(19) United States
(12) Patent Application Publication
(10) Pub. No.: US 2016/0055272 A1
(43) Pub. Date: Feb. 25, 2016

(54) METHOD AND COMPILING SYSTEM FOR GENERATING TESTBENCH FOR IC

(71) Applicant: MediaTek Singapore Pte. Ltd., Singapore (SG)

(72) Inventors: Zhidong CHEN, Beijing (CN); Yunyang SONG, Beijing (CN); Wenting HOU, Beijing (CN)

(21) Appl. No.: 14/833,299

(22) Filed: Aug. 24, 2015

(30) Foreign Application Priority Data
Aug. 25, 2014 (CN) 201410422922.1

(51) Int. Cl. G06F 17/50

(52) U.S. Cl. CPC G06F 17/505; G06F 2217/14

(57) ABSTRACT

A method for generating a testbench for an IC is provided. Design information of the IC is obtained according to a bus configuration. The design information is displayed in a graphical user interface (GUI). The design information is modified according to a first user input. It is determined whether the modified design information is correct according to a register transfer level (RTL) code of the IC. The testbench for the IC is generated according to the modified design information when the modified design information is correct.

### CROSS REFERENCE TO RELATED APPLICATIONS

This Application claims priority of China Patent Application No. 201410422922.1, filed on Aug. 25, 2014, the entirety of which is incorporated by reference herein.

### BACKGROUND OF THE INVENTION

1. Field of the Invention

The invention relates to integrated circuit (IC) design verification, and more particularly to methods and compiling systems for generating a testbench for an IC.

2. Description of the Related Art

Rapid advances in computing technology have made it possible to perform trillions of computational operations per second on data sets that are sometimes as large as trillions of bytes. These advances can largely be attributed to the dramatic improvements in semiconductor design and manufacturing technologies that have made it possible to integrate tens of millions of devices onto a single chip.

Integration densities continue to increase at a rapid pace to keep up with the insatiable demand for smaller, faster, and more complex electronic devices and computers. As processing technology constantly advances, circuit designers and program managers will face ever more difficult challenges. With the gradual increase in the complexity and component density for designing integrated circuits (IC), design verification of the ICs takes more time and manpower to complete. Therefore, the circuit designers and the program managers are finding it increasingly difficult to meet project deadlines.

Therefore, a method for automatically generating a testbench to verify an IC is desired.

### BRIEF SUMMARY OF THE INVENTION

A method and a compiling system for generating a testbench for an integrated circuit (IC) are provided. An embodiment of a method for generating a testbench for an IC is provided. Design information of the IC is obtained according to a bus configuration. The design information is displayed in a graphical user interface (GUI). The design information is modified according to a first user input. It is determined whether the modified design information is correct according to a register transfer level (RTL) code of the IC. The testbench for the IC is generated according to the modified design information when the modified design information is correct. In addition, the design information of the IC is obtained from at least one testbench for at least one of other ICs according to the bus configuration.

Furthermore, an embodiment of a compiling system for generating a testbench for an integrated circuit (IC) is provided. The compiling system comprises a processing unit, a display unit, and a user-input unit. The processing unit obtains the design information of the IC according to a bus configuration. The display unit displays the design information in a graphical user interface (GUI). The user-input unit receives the first user input. The processing unit modifies the design information according to the first user input, and determines whether the modified design information is correct according to a register transfer level (RTL) code of the IC. The processing unit generates the testbench for the IC according to the modified design information when the modified design information is correct. In addition, the processing unit obtains the design information of the IC from at least one testbench for another IC according to the bus configuration.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram of a compiling system according to an embodiment of the invention;

FIG. 2 is a flow chart of a method for generating a testbench for an IC according to an embodiment of the invention;

FIG. 3 is a flow chart illustrating obtaining of the design information (i.e. step S220 of FIG. 2) according to an embodiment of the invention;

FIG. 4 is a flow chart illustrating obtaining of the design information (i.e. step S220 of FIG. 2) according to another embodiment of the invention;

FIG. 5 is a flow chart illustrating obtaining of the design information (i.e. step S220 of FIG. 2) according to yet another embodiment of the invention; and

FIG. 6 is a GUI illustrating design information of an IC according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

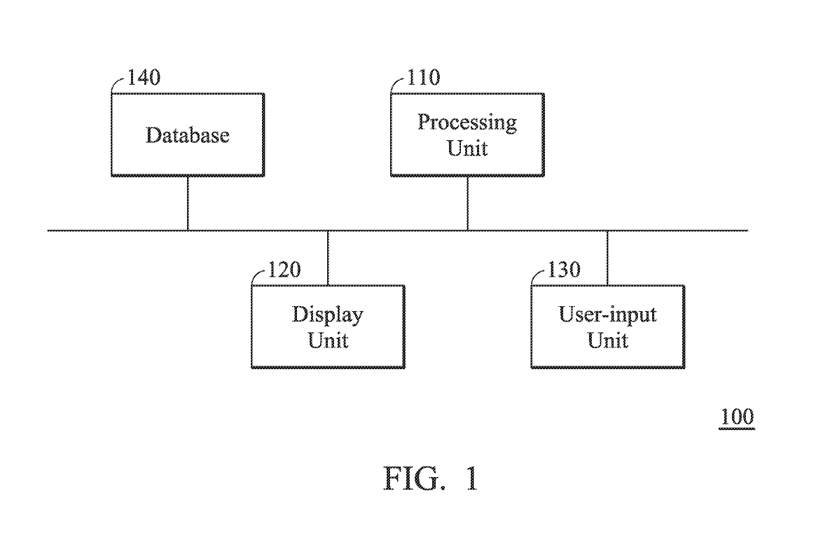

FIG. 1 is a schematic diagram of a compiling system 100 according to an embodiment of the invention. The compiling system 100 comprises a processing unit 110, a display unit 120, a user-input unit 130 and a database 140. The compiling system 100 automatically generates a testbench for an integrated circuit (IC) according to a bus configuration of the IC.

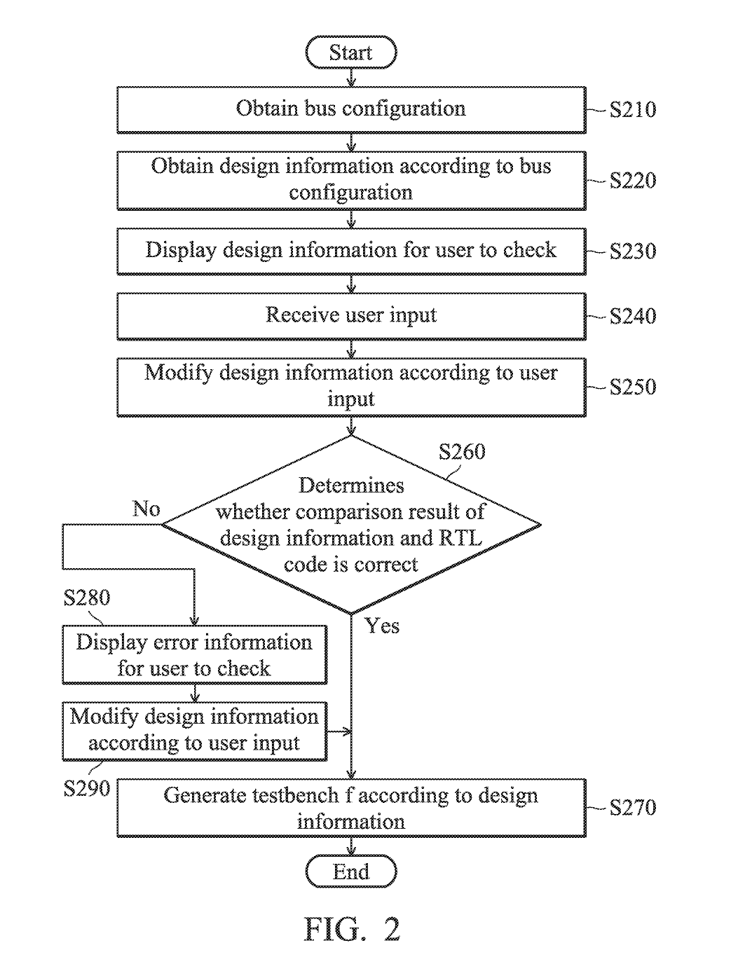

FIG. 2 is a flow chart of a method for generating a testbench for an IC according to an embodiment of the invention. Please refer to FIG. 1 and FIG. 2 together. In step S210, the processing unit 110 obtains the bus configuration BusConf of the IC. Next, in step S220, the processing unit 110 obtains/extracts the design information DE of the IC according to the bus configuration BusConf. A detailed description of the steps taken by the processing unit 110 to obtain the design information DE of the IC is provided in following paragraphs. Next, in step S230, the processing unit 110 displays the design information DE on a graphical user interface (GUI) in the display unit 120 for the user to check. In one embodiment, the GUI is a web page. In another embodiment, the processing unit 110 converts the design information DE into an output file of a specific format, e.g. txt, doc, docx, xls, csv, xlsx, xml, IP-XACT and so on, so that the user can modify the design information DE. When the user finds that the design information DE has errors or incomplete data (omissions), the user can modify or edit the design information DE via the user-input unit 130 (e.g. keyboard, touch panel, etc.) (step S240). Next, in step S250, the processing unit 110 modifies the design information DE according to the received user input. According to the invention, even if the user does not actually modify or edit the design information DE (e.g., there is no error found), because of the check operation, we can still call that the processing unit 110 modifies the design information DE according to the received user input. In step S260, the processing unit 110 automatically determines whether a comparison result of the design information DE and a register transfer level (RTL) code RTLcode of the IC is correct, i.e. whether the design information DE is correct. If the comparison result is correct, the processing unit 110 generates the testbench TB for the IC according to the design information DE (step S270). Conversely, if the comparison result is incorrect, the processing unit 110 displays the design information DE on the GUI of the display unit 120 (step S280). According to an embodiment, the processing unit may further remind the user about which part of the design information DE has an error or which part of the design information DE needs supplement data. In step S290, the processing unit 110 receives the user's modification via the user-input unit 130, and modifies the design information DE according to the user's modification. Next, the processing unit 110 generates the testbench TB for the IC according to the modified design information DE (step S270). Furthermore, according to an embodiment, after obtaining the testbench TB, the processing unit 110 converts the testbench TB into an output file of a specific format. In another embodiment, in step S270, the processing unit 110 may generate an intermediary file of a specific format according to the modified design information DE in advance, such as IP-XACT, upf, document (txt, xml, doc, xls, docx, xlsx, csv), c/c++ source code/head file and so on, and then the processing unit 110 generates the testbench TB for the IC according to the intermediary file of the specific format. It should be noted that, in the embodiment having the intermediary file, the testbench TB that is finally generated may be in various formats depending on the user's choice. Furthermore, in the embodiment, the processing unit 110 may store the design information DE of the IC in the database 140 for subsequent use, so that other ICs may use the stored design information DE to generate the testbench.

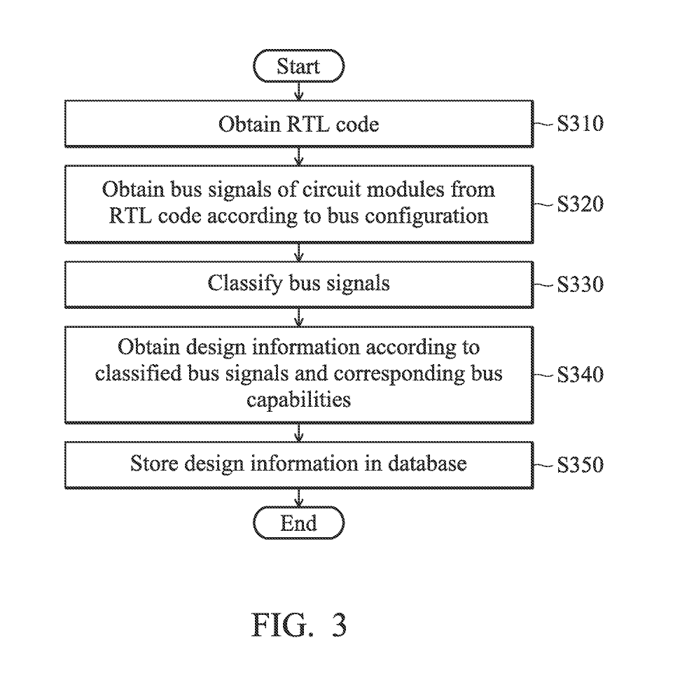

FIG. 3 is a flow chart illustrating obtaining of the design information DE (i.e. step S220 of FIG. 2) according to an embodiment of the invention. In step S310, the processing unit 110 of FIG. 1 obtains the RTL code RTLcode of the IC. Next, in step S320, the processing unit 110 automatically obtains the bus signals of each circuit module within the IC according to the bus configuration BusConf, and each bus signal has a bus capability. Next, in step S330, the processing unit 110 classifies the bus signals according to a specific classification rule. For example, in the RTL code RTLcode, each bus signal has a specific name for identification, and the name of the bus signal is related to its function. In general, the signals belonging to the same interface would substantially use the same naming rule. Therefore, the processing unit 110 may classify various bus signals according to the naming rules. The invention is not limited by this. Next, in step S340, the processing unit 110 obtains the design information DE of the IC according to the classified bus signals and the corresponding bus capabilities. Next, the processing unit 110 stores the design information DE in the database 140 (step S350).

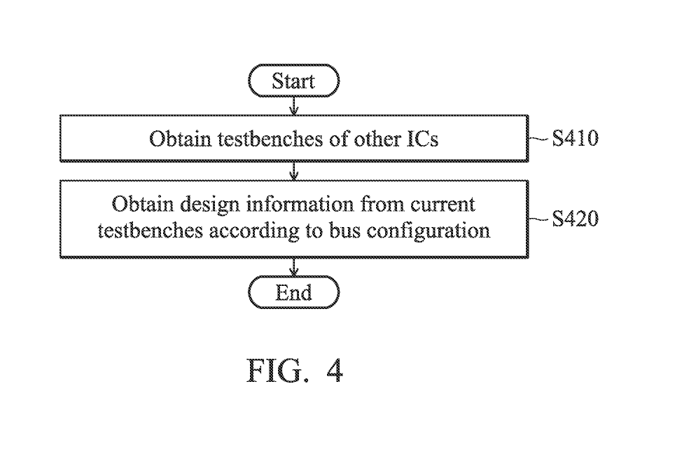

FIG. 4 is a flow chart illustrating obtaining of the design information DE (i.e. step S220 of FIG. 2) according to another embodiment of the invention. First, in step S410, the processing unit 110 of FIG. 1 obtains at least one testbench TB_O of other ICs, wherein each testbench TB_O is the testbench for another IC generated in advance. Next, in step S420, the processing unit 110 obtains the design information DE from the at least one testbench TB_O according to the bus configuration BusConf.

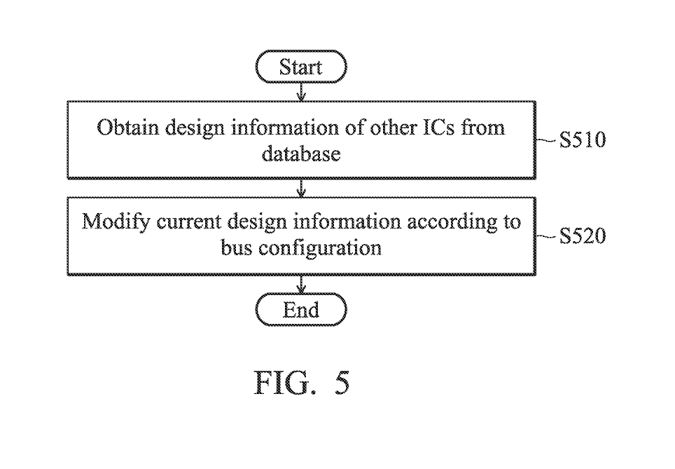

FIG. 5 is a flow chart illustrating obtaining of the design information DE (i.e. step S220 of FIG. 2) according to yet another embodiment of the invention. First, in step S510, the processing unit 110 of FIG. 1 obtains the design information DE_O of at least one of other ICs from the database 140, wherein the design information DE_O is the design information of the other IC currently stored in the database 140. Next, in step S520, the processing unit 110 modifies the current design information DE_O to obtain the design information DE of the IC according to the bus configuration BusConf.

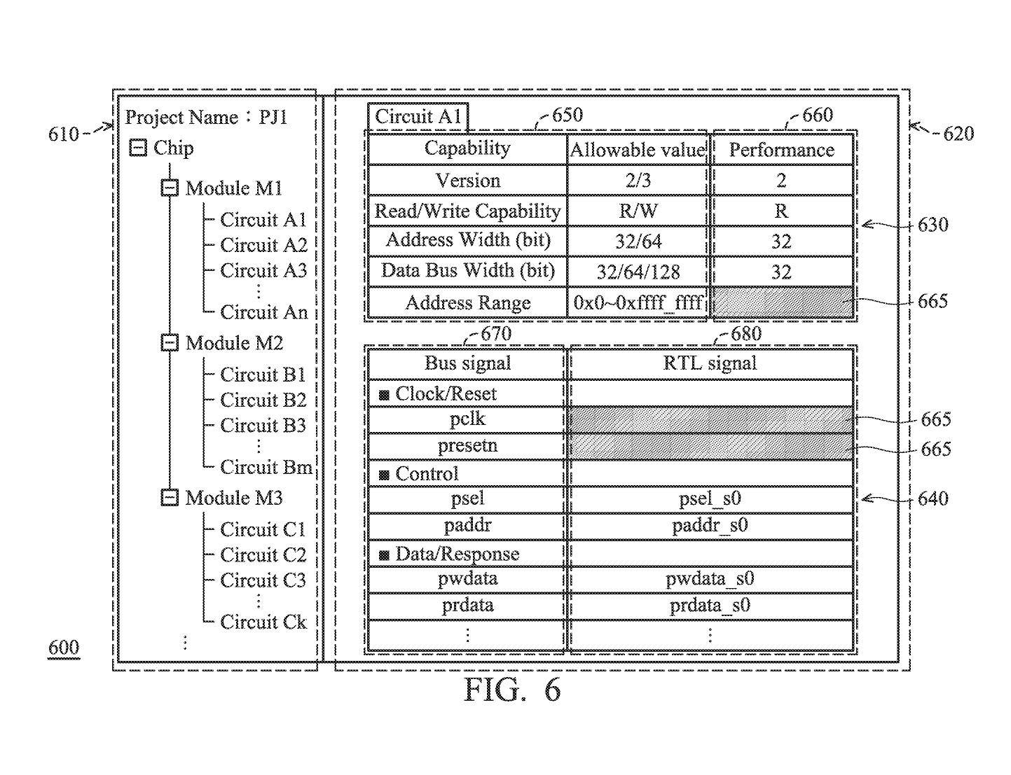

FIG. 6 is a GUI 600 illustrating design information of an IC according to an embodiment of the invention. In the GUI 600, an area 610 represents a project name and a circuit hierarchy of the IC. For example, the project name of the IC is PJ1. The IC comprises the modules M1, M2 and M3. The module M1 comprises the circuits A1-An, the module M2 comprises the circuits B1-Bm, and the module M3 comprises the circuits C1-Ck. Moreover, an area 620 represents the design information of the circuit A1 of the module M1 selected by the user. In the area 620, a table 630 represents the capability parameters of the buses in the circuit A1, and a table 640 represents the signal list of the buses of the circuit A1. In the table 630, the fields shown in label 650 are obtained by a processing unit (e.g. 110 of FIG. 1) within a compiling system according to the bus configuration BusConf, and the fields shown in label 660 are obtained by the processing unit according to the RTL code. For example, the field “Version” represents the specification of the bus, which allows a value of 2/3, and the processing unit automatically obtains the corresponding parameter of 2 from the RTL code. The field “Read/Write Capability” represents the access direction of the bus, which allows a value of R/W, and the processing unit automatically obtains the corresponding parameter of R (i.e. read direction) from the RTL code. The field “Address Width” represents the width of the address bus, which allows a value of 32/64, and the processing unit automatically obtains the corresponding parameter of 32 (i.e. 32 bits) from the RTL code. The field “Data Bus Width” represents the width of the data bus, which allows a value of 32/64/128, and the processing unit automatically obtains the corresponding parameter of 32 (i.e. 32 bits) from the RTL code. The field “Address Range” represents the address range of the address bus, which allows a value of 0x0˜0xffff_ffff. In the embodiment, due to the processing unit not being able to obtain the full corresponding parameters from the RTL code, the processing unit will highlight the related field via the GUI 600 (e.g. the prompt information shown in label 665), so as to notify the user that editing and modifying is required. Furthermore, in the table 640, the fields shown in 670 are obtained by the processing unit of the compiling system according to the bus configuration BusConf, and the fields shown in 680 are obtained by the processing unit according to the RTL code. In the embodiment, the processing unit 110 can obtain bus signals with various functions according to the bus configuration BusCon. For example, the field “Clock/Reset” represents the bus signal that can function as a frequency signal (e.g. pclk) and a reset signal (e.g. present). The field “Control” represents the bus signal that can function as a control signal (e.g. psel, paddr). The field “Data/Response” represents the bus signal that can function as a data signal (e.g. pwdata, prdata) and a response signal. In response to various bus signals, the processing unit automatically obtains the RTL signal names from the RTL code according to the naming rule, such as “paddr_s0” corresponding to the bus signal paddr, and then the bus signals are classified. As described above, the processing unit will display the design information DE in the GUI 600, and mark errors and/or incomplete parts of the design information DE for the user to check, modify, or supplement. The GUI 600 shown in FIG. 6 is for illustrate only, and the invention is not limited by this.

According to the embodiments of the invention, the methods and the compiling systems can automatically obtain the required information from the RTL code, and then automatically generate the testbench for the IC. Thus, it is ensured that the testbench is consistent with the RTL code, thereby decreasing debug time for design verification. Furthermore, the design verification environment of the IC can also be established fast and automatically.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for generating a testbench for an integrated circuit (IC), comprising:
obtaining design information of the IC according to a bus configuration;
displaying the design information in a graphical user interface (GUI);
modifying the design information according to a first user input;
determining whether the modified design information is correct according to a register transfer level (RTL) code of the IC; and
generating the testbench for the IC according to the modified design information when the modified design information is correct.

2. The method as claimed in claim 1, further comprising:
displaying prompt information in the GUI when the modified design information is incorrect;
modifying the design information according to a second user input; and
generating the testbench for the IC according to the modified design information.

3. The method as claimed in claim 1, wherein the step of obtaining the design information of the IC according to the bus configuration further comprises:
obtaining a plurality of bus signals of a circuit module of the IC from the RTL code of the IC according to the bus configuration, wherein each of the bus signals has a corresponding bus capability;
classifying the bus signals according to a classification rule;
obtaining the design information according to the classified bus signals and the corresponding bus capabilities; and
storing the design information in a database.

4. The method as claimed in claim 3, wherein the classification rule is related to a naming rule of the bus signals.

5. The method as claimed in claim 3, wherein the corresponding bus capability comprises a bus width and an access direction of the corresponding bus signal.

6. The method as claimed in claim 3, wherein the design information comprises names of the bus signals and the corresponding bus capabilities.

7. The method as claimed in claim 3, wherein a user modifies the bus signals and the corresponding bus capabilities in the GUI via the first user input.

8. The method as claimed in claim 1, wherein the step of obtaining the design information of the IC according to the bus configuration further comprises:
obtaining the design information of the IC from at least one testbench for at least one of other ICs according to the bus configuration.

9. The method as claimed in claim 1, wherein the step of obtaining the design information of the IC according to the bus configuration further comprises:
obtaining design information of at least one of other ICs from a database; and
modifying the design information of the at least one of other ICs according to the bus configuration, to obtain the design information of the IC.

10. The method as claimed in claim 1, wherein the GUI is a web page.

11. The method as claimed in claim 1, wherein the step of generating the testbench for the IC according to the modified design information when the modified design information is correct further comprises:
generating an intermediary file with a specific format according to the modified design information; and
generating the testbench according to the intermediary file.

12. A compiling system for generating a testbench for an integrated circuit (IC), comprising:
a processing unit, obtaining design information of the IC according to a bus configuration;
a display unit, displaying the design information in a graphical user interface (GUI); and
a user-input unit, receiving a first user input,
wherein the processing unit modifies the design information according to a first user input, and determines whether the modified design information is correct according to a register transfer level (RTL) code of the IC,
wherein the processing unit generates the testbench for the IC according to the modified design information when the modified design information is correct.

13. The compiling system as claimed in claim 12, wherein the processing unit displays prompt information in the GUI of the display unit when the modified design information is incorrect, and the processing unit modifies the design information according to a second user input received by the user-input unit, wherein the processing unit generates the testbench for the IC according to the modified design information.

14. The compiling system as claimed in claim 12, wherein the processing unit obtains a plurality of bus signals of a circuit module of the IC from the RTL code of the IC according to the bus configuration, wherein each of the bus signals has a corresponding bus capability, and the processing unit classifies the bus signals according to a classification rule, and obtains the design information according to the classified bus signals and the corresponding bus capabilities, wherein the processing unit stores the design information in a database.

15. The compiling system as claimed in claim 14, wherein the classification rule is related to a naming rule of the bus signals.

16. The compiling system as claimed in claim 14, wherein the corresponding bus capability comprises a bus width and an access direction of the corresponding bus signal.

17. The compiling system as claimed in claim 14, wherein the design information comprises names of the bus signals and the corresponding bus capabilities.

18. The compiling system as claimed in claim 14, wherein a user modifies the bus signals and the corresponding bus capabilities in the GUI via the first user input.

19. The compiling system as claimed in claim 12, wherein the processing unit obtains the design information of the IC from at least one testbench for another IC according to the bus configuration.

20. The compiling system as claimed in claim 12, wherein the processing unit obtains design information of at least one of other ICs from a database, and modifies the design information of the at least one of other ICs according to the bus configuration, to obtain the design information of the IC.

21. The compiling system as claimed in claim 12, wherein the GUI is a web page.

22. The compiling system as claimed in claim 12, wherein the processing unit generates an intermediary file with a specific format according to the modified design information, and generates the testbench according to the intermediary file.
